(19) United States
(12) Patent Application Publication
(10) Pub. No.: US 2007/0102171 A1
(43) Pub. Date: May 10, 2007

(54) Device For Soil Cultivation

(75) Inventor: Pertti Huuhka, Sauvo (FI)

Correspondence Address: JAMES C. LYDON, 100 DAINGERFIELD ROAD, SUITE 100, ALEXANDRIA, VA, 22314, US

(73) Assignee: OY, MATALLIASENNUS HUUHKA, Sauvo (FI)

(21) Appl. No.: 10/561,391

(22) PCT Filed: Jul. 1, 2004
(86) PCT No.: PCT/FI04/00411

§ 371 Date: Dec. 19, 2005

(30) Foreign Application Priority Data
Jul. 1, 2003 (FI) 20030990

(51) Int. Cl. A01B 31/00

(52) U.S. Cl. 172/690

(57) ABSTRACT

This invention relates to a cultivation device intended for the cultivation of soil and pulled by a vehicle, the device comprising a frame (6) with a drawbar (4) attached to the frame, or which frame (6) is intended to be coupled to a drawbar (4); an attachment shaft (8) for mould-boards (10′, 10″), the shaft extending substantially in the direction of the longitudinal axis of the frame (6); and mould-boards (10′, 10″); and a drawbar (4) which is coupled or can be coupled substantially centrally to the frame (6) so that the angle, between the longitudinal axis of the frame (6,) being substantially transversal regarding the driving direction during cultivation and the drawbar (4) being substantially in parallel with the driving direction, is arranged to be adjustable. A cultivation device according to the invention is characterised in that there are two types of mouldboards (10′, 10″); first mouldboards (10′) which during cultivation turn the soil to the right in relation to the driving direction; and second mouldboards (10″) which during cultivation turn the soil to the left in relation to the driving direction; that the mouldboards (10′, 10″) are fastened to the mouldboard attachment shaft (8) so that the first mouldboards (10′) are substantially parallel in relation to each other, the second mouldboards (10″) are substantially parallel in relation to each other, and the first mouldboards (10′) are directed in a substantially different direction in relation to the second mouldboards (10″); and that the mouldboard (10′, 10″) attachment shaft (8) is arranged to be rotated around its longitudinal axis so that there are at least two attachment shaft (8) positions to be used in the cultivation; a first position where the first mouldboards (10′) are arranged during cultivation to turn the soil to the right in relation to the driving direction; and a second position where the second mouldboards (10″) are arranged during cultivation to turn the soil to the left in relation to the driving direction.

### TECHNICAL FIELD

The object of this invention is a device for soil cultivation intended to be pulled by a vehicle.

### PRIOR ART

There are many different cultivation devices on the market intended for the cultivation of soil and having a drawbar, a frame and mouldboards.

On the market one can find light cultivation devices with the drawbar attached at the centre of the cultivation device, so that that portion of the cultivation device, where the mouldboards are attached, can be turned in relation to the drawbar so that either the mouldboards on the right hand side or on the left hand side will run in front during the cultivation process. In these cultivation devices the mouldboards are symmetric and such that the soil will be directed to the right or to the left in relation to the mouldboard, depending on whether the right hand or the left hand mouldboards run in the front. Due to the mouldboards turning the soil into both directions a cultivation device of this type requires a greater force than cultivation devices provided with mouldboards turning the soil only into one direction, because the force required by each mouldboard is greater than the force required by a corresponding asymmetric mouldboard turning the soil in only one direction.

On the market one can also find devices intended for ploughing cultivation and having two sets of mouldboards turning the soil into different directions and located on opposite sides of frame of the cultivation device. In these devices one end of the cultivation device is attached to a pulling vehicle. The frame of the cultivation device can be turned either to the right side or to the left side in relation to the driving direction. When the frame of the cultivation device is turned to the right side those mouldboards intended to turn the soil to the right are located against the soil and thus turning the soil, and those mouldboards intended to turn the soil to the left point upwards and do not turn the soil. Correspondingly, if the frame of the cultivation device is turned to the left side those mouldboards intended to turn the soil to the left are located against the soil and thus turning the soil, and those mouldboards intended to turn the soil to the right point upwards and do not turn the soil. During back and forth driving the frame is alternately turned from one side to the other, and thus the soil is always turned into the same direction. As a cultivation device of this kind is pulled from one end it must have a very rigid structure, and thus it is heavy. The pulling vehicle must be driven with one wheel in the furrow and thus in a tilted position, as the area to be cultivated remains on the other side of the driving direction.

### LIST OF DRAWINGS

FIG. 1a shows schematically from the upper right a cultivation device turning soil to the left.

FIG. 1b shows schematically from the upper left a cultivation device turning soil to the right.

FIG. 2a shows schematically the locking arrangement of the mouldboard attachment arm in a cultivation device turning soil to the left.

FIG. 2b shows schematically the locking arrangement of the mouldboard attachment arm in a cultivation device turning soil to the right.

FIG. 3 shows schematically a cultivation device comprising a rear harrow.

### GENERAL DESCRIPTION OF THE INVENTION

The object of this invention is to provide a cultivation device having the advantages of the light cultivation device described above, but requiring substantially less force to be pulled. A further object is to provide a cultivation device, which is suitable for ploughing cultivation and which has the advantages of the light cultivation device described above.

This invention is characterised in what is presented in the independent claims below.

This invention relates to a device for soil cultivation and pulled by a vehicle, the device comprising a frame with a drawbar attached to the frame, or whereby the frame is intended to be coupled to a drawbar; an attachment shaft substantially in the direction of the longitudinal axis of the frame; and mouldboards; and a drawbar which is coupled or can be coupled substantially centrally to the frame so that the angle between the longitudinal axis of the frame being substantially transversal regarding the driving direction during cultivation, and the drawbar being substantially in parallel with the driving direction, is arranged to be adjustable.

The cultivation device is characterised in that

a) there are two types of mouldboards; first mouldboards which during cultivation turn the soil to the right in relation to the driving direction; and second mouldboards which during cultivation turn the soil to the left in relation to the driving direction;

b) the mouldboards are fastened to the mouldboard attachment shaft so that the first mouldboards are substantially parallel in relation to each other, the second mouldboards are substantially parallel in relation to each other, and the first mouldboards are directed in a substantially different direction in relation to the second mouldboards; and

c) the mouldboard attachment shaft is arranged to be rotated around its longitudinal axis so that there are at least two attachment shaft positions to be used in the cultivation; a first position where the first mouldboards are arranged during cultivation to turn the soil to the right in relation to the driving direction; and a second position where the second mouldboards are arranged during cultivation to turn the soil to the left in relation to the driving direction.

### ADVANTAGEOUS EMBODIMENTS OF THE INVENTION

In a typical cultivation device according to the invention the drawbar, which is substantially in parallel with the driving direction, is fastened substantially centrally to the frame of the cultivation device, so that the angle between the longitudinal axis of the frame being substantially transversal regarding the driving direction during cultivation, and the drawbar, is arranged to be adjustable. A cultivation device according to the invention is characterised in that

a) there are two types of mouldboards; first mouldboards, which during cultivation direct the soil to the right in relation to the driving direction; and second mouldboards, which during cultivation direct the soil to the left in relation to the driving direction;

b) the mouldboards are fastened to the mouldboard attachment shaft so that the first mouldboards are substantially parallel in relation to each other, the second mouldboards are substantially parallel in relation to each other, and the first mouldboards are directed in a substantially different direction in relation to the second mouldboards; and

c) the mouldboard attachment shaft is arranged to be rotated around its longitudinal axis so that there are at least two attachment shaft positions to be used in the cultivation; a first position where the first mouldboards are arranged during cultivation to turn the soil to the right in relation to the driving direction; and a second position turn the soil to the left in relation to the driving direction.

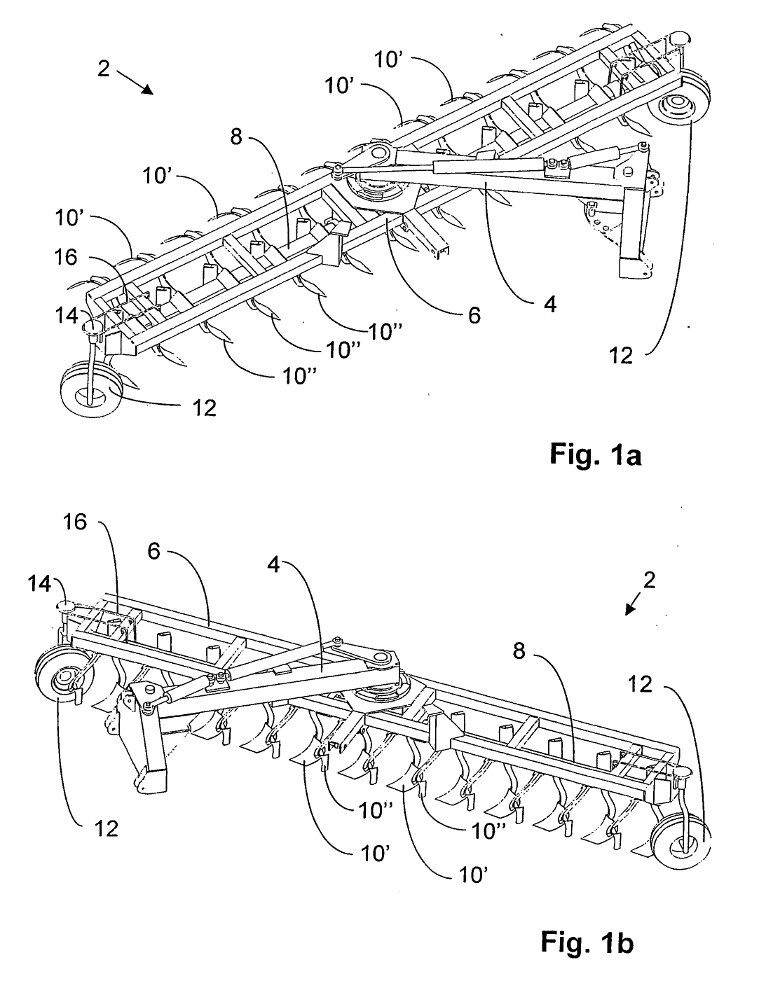

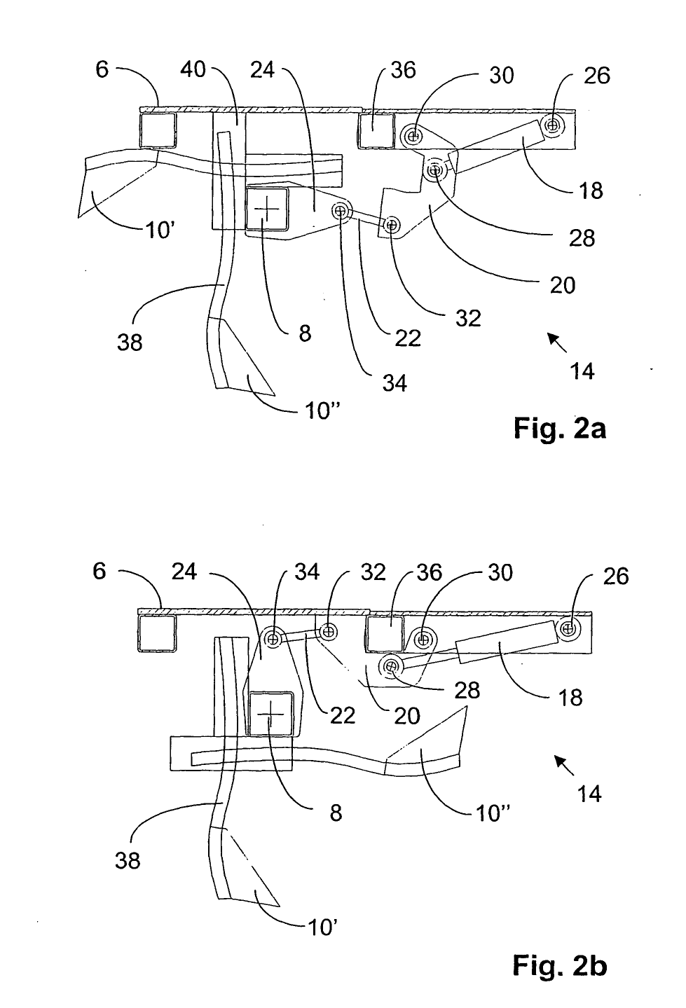

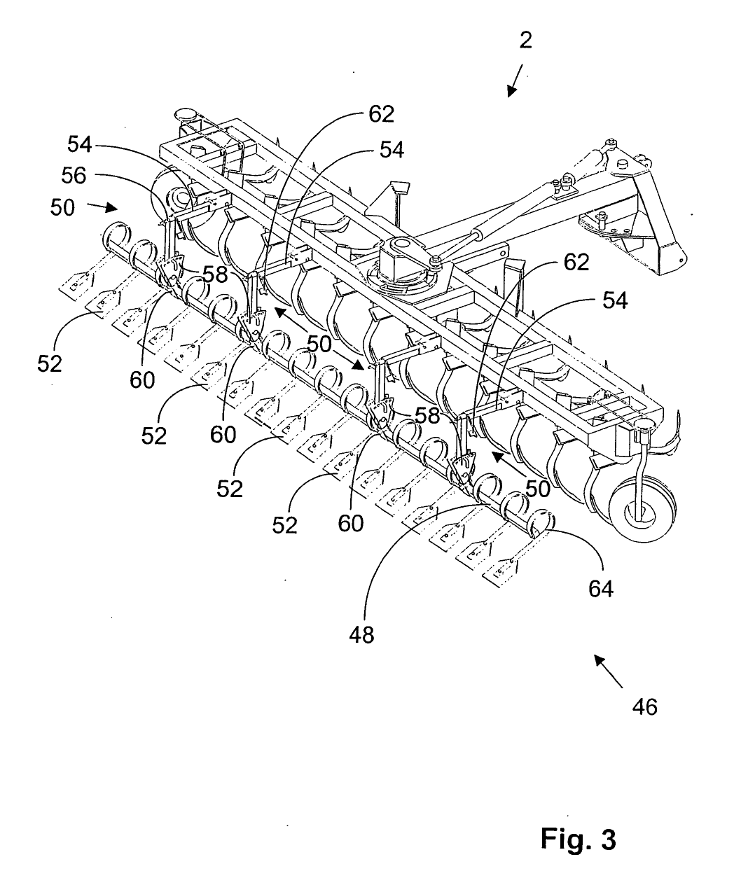

The invention is described in more detail below with reference to the enclosed figures. FIGS. 1a and 1b show schematically a cultivation device 2 according to an advantageous embodiment of the invention, which is intended for the cultivation of soil and to be pulled by a vehicle, whereby the device comprises a drawbar 4; a frame 6; an attachment shaft 8 substantially in parallel with the longitudinal axis of the frame 6 for attachment of the mouldboards 10′, 10″; and mould-boards 10′, 10″. FIGS. 2a and 2b show schematically a locking arrangement of the attachment shaft 8 intended for different turning directions of the cultivation device according to an advantageous embodiment of the invention. FIG. 3 shows schematically a cultivation device 2 according to the invention comprising a rear harrow.

The cultivation device 2 has a drawbar 4, which during cultivation is substantially in parallel with the driving direction, and which is fastened substantially centrally to the frame 6 of the cultivation device 2, so that the angle between the longitudinal axis of the frame 6 being substantially transversal regarding the driving direction during cultivating, and the drawbar 4, is arranged to be adjustable.

There are two types of mouldboards 10′, 10″; first mouldboards 10′ which during cultivation direct the soil to the right in relation to the driving direction (FIGS. 1b and 2b); and second mouldboards 10″ which during cultivation direct the soil to the left in relation to the driving direction (FIGS. 1a and 2a). The mould-boards 10′, 10″ are attached to the mouldboard attachment shaft 8 so that the first mouldboards 10′ are substantially parallel in relation to each other, the second mouldboards 10″ are mutually substantially in parallel, and the first mouldboards 10′ are directed in a substantially different direction in relation to the second mouldboards 10″. The mouldboard attachment shaft 8 is arranged to be rotated around its longitudinal axis so that there are at least two attachment shaft 8 positions to be used in the cultivation; a first position where the first mouldboards 10′ are arranged during cultivation to turn the soil to the right in relation to the driving direction; and a second position where the second mouldboards 10″ are arranged during cultivation to turn the soil to the left in relation to the driving direction. In these positions only either the first 10′ or the second 10″ mouldboards turn the soil.

The cultivation device can be a light cultivation device having a cultivation depth of about 5 to 15 cm, advantageously about 5 to 10 cm. The cultivation device can also be a plough with a cultivation depth of about 10 to 25 cm, advantageously about 10 to 15 cm.

The angle between the drawbar 4 and the frame 6 can be adjusted into at least two different positions, whereby in the first position the acute angle between the drawbar 4 and the longitudinal axis of the frame 6 is on the right side in relation to the driving direction, and in the second position the acute angle is on the left side in relation to the driving direction. The angle between the drawbar 4 and the longitudinal axis of the frame 6 can be adjustable between about 0° and 180°, advantageously between about 10° and 160°. The adjustment is typically realized either hydraulically or pneumatically, advantageously hydraulically using a hydraulic cylinder 16, and the adjustment can be stepless.

The first mouldboards 10′ and the second mouldboards 10″ are typically mirror images of each other.

The mouldboard attachment shaft 8 is typically fastened at both ends to the frame 6 of the cultivation device. Particularly if the attachment shaft is long it can also be fastened at several points to the frame 6 of the cultivation device. The shaft 8 can also be a multiple part component, so that the frame 6 contains several individual, rotatable mouldboard attachment shafts 8 according to the invention. The mouldboard attachment shaft 8 can be mounted in bearings at least at its both ends. If there are more shafts each of them can be mounted in bearings at least at their both ends. The mouldboard attachment shaft 8 can be typically rotated about 180° around its longitudinal axis. Depending on the type and function of the cultivation device it can be advantageously rotated only about 90° or even only about 60°. Typically the mouldboard attachment shaft 8 can be rotated either hydraulically or pneumatically, advantageously using a hydraulic cylinder 18.

The mouldboards 10′, 10″ can be resiliently attached to the attachment shaft 8, advantageously by springs. Alternatively, each mouldboard 10′, 10″ can be attached to the attachment shaft using at least one shear pin or the like, so that if a single mouldboard 10′, 10″ hits an unyielding obstacle, for instance a large stone, then the shear pin breaks and the mouldboard 10′ or 10″ can turn or come loose and thus prevent damage of the cultivation device 2.

Typically the cultivation device according to the invention has a wheel or wheels 12. Advantageously the cultivation device has a wheel 12 at both ends of the frame 6. The wheels 12 support the cultivation device so that the cultivation is effected at the desired depth. The height of the wheels 12 in relation to the frame 6 of the cultivation device 2 can be adjustable, advantageously mechanically with the aid of a crank, so that the cultivation depth of the cultivation device 2 is adjusted by adjusting their height. The wheels 12 can be arranged to be turned in parallel with the driving direction by transmitting the rotational motion of the attachment shaft 8 to the shaft 14 turning the wheels 12, for instance via a chain drive 16.

FIGS. 2a and 2b show schematically the locking arrangement of the attachment shaft 8 for the mouldboards 10′, 10″ according to an advantageous embodiment of the invention. In this arrangement the attachment shaft 8 is locked in two positions, which are used during soil cultivation. In the first position (FIG. 2b) the mouldboards 10′ are during cultivation arranged to turn the soil to the night in relation to the driving direction, and in the second position (FIG. 2a) the mouldboards 10″ are during cultivation arranged to turn the soil to the left in relation to the driving direction.

In an arrangement according to that one illustrated in FIGS. 2a and 2b the attachment shaft 8 is rotated from the first position to the second position or from the second position to the first position by a hydraulic cylinder 18 via the locking block 20 of the mouldboards 10′, 10″ attachment shaft 8 and the lever arm 24 of the attachment shaft 8. At the first end the hydraulic cylinder 18 is pivotally supported by a first fastening shaft 26 and fastened to the frame 6, and at its second end it is supported by a second fastening shaft 28 and fastened to the central part of the locking block 20. The locking block 20 is pivotally attached at its first end via a third fastening shaft 30 to the frame 6 and at its second end via a fourth fastening shaft 32 to the first end of a transmission arm 22. The transmission arm 22 is at its second end pivotally fastened via a fifth fastening shaft 34 to the first end of the lever arm 24 on the attachment shaft 8. The second end the lever arm 24 is stationary fastened to the attachment shaft 8, so that the motion of the lever arm 24 rotates the shaft 8. The shape of the locking block 20 is adapted so that in the first position of the attachment shaft 8 it will abut the lower surface and the side surface of the frame's bar 36, with a square cross section, opposite the attachment shaft 8.

The fastening shafts 30, 32 and 34 are arranged in relation to each other so that if the attachment shaft 8 is in the first position (FIG. 2b) and the attachment shaft 8 is rotated clockwise, as during ploughing the force acting on the mouldboards 10′ tends to do, then the rotation of the attachment shaft 8 is prevented. Rotation of the shaft 8 is prevented because the lever arm 24 presses via the transmission arm 22 the locking block 20 against the bar 36 of the frame 6. The lever arm 22 rotates the locking block 20 clockwise around the fastening shaft 30 when the fastening shaft 32 is above the level formed by the fastening shafts 30 and 34. On the other hand the fastening shafts 26, 28 and 30 are arranged in relation to each other so that a shortening of the hydraulic cylinder 18 rotates (FIGS. 2b and 2a) the locking block 20 anticlockwise around the fastening shaft 30. The shortening rotates the locking block 20 anticlockwise when the fastening shaft 28 is below the level formed by the fastening shafts 26 and 30. On the other hand the fastening shafts 32 and 34 of the transmission arm 22 and the attachment shaft 8 are arranged in relation to each other so that an anticlockwise rotation of the locking block 20 will rotate the attachment shaft 8 clockwise. In the embodiment example the support arm 38 attaches one or more mouldboards 10″ to the attachment shaft 8, and it has a support arm 38 extension 40 on the opposite side of the attachment shaft 8, as seen from the mouldboard 10′, whereby the extension 40 abuts the frame 6 when the attachment shaft 8 has rotated to its second position (FIG. 2a). Then the attachment shaft 8 is prevented from rotating further clockwise, for instance due to the force acting on the mouldboards 10″ during ploughing

Obviously the attachment shaft 8 can be locked in its first or second position also with aid of other means 14 than those described above, so that the actuator 18 rotating the attachment shaft 8 will release the locking but does not actually keep the attachment shaft 8 in the locked position, and/or that a rotation of the attachment shaft 8 due to the rotational forces, which due to cultivating the soil act on the mouldboards 10′, 10″ and via them on the attachment shaft 8, is prevented in other ways than that described above.

If the attachment shaft 8 is locked in its first or second position in the way described above, then it is not necessary to lock the attachment shaft 8 into these positions (and to unlock it from these positions) by any particular means, nor to dimension the actuator rotating the attachment shaft 8 from the first position to the second position or vice versa so that it also is able to keep the shaft in these positions during cultivation of the soil. Thus the arrangement enables the use of a quite small, and thus also a more economical and lighter actuator, for instance a small hydraulic cylinder 18 for rotating the attachment shaft 8 from one position to the other.

FIG. 3 shows schematically an advantageous embodiment of a device 2 for soil cultivation according to the invention comprising a rear harrow 46. In other respects the embodiment is according to that described above, for instance to that presented in the FIGS. 1a and 1b, and it may also be for instance according to that presented in FIGS. 2a and 2b, but a rear harrow 46 is fastened to its frame. Because according to the invention the frame 6 of the cultivation device 2 is typically in a position, which is somewhat turned from the position transversal to the driving direction, for instance turned about 50°, then the rear harrow 46 will also be in the same position in relation to the driving direction. The rear harrow 46 according to the embodiment comprises a frame bar 48 of the harrow 46 with, a length equalling roughly the length of the frame 6 of the cultivation device 2; suspension means 50 with which the harrow is suspended in the frame 6 of the cultivation device; and harrow blades 52. In the embodiment according to the figure there are four suspension means 50, and they comprise a fastening body 54, which is fastened to the frame 6 of the cultivation device 2. Each fastening body 54 has roughly in the horizontal plane a shaft 56, which is substantially perpendicular to the frame bar 48, and from which an adjustment member 58 of the suspension means 50 is pivotally suspended. The adjustment members 58 are fastened to the frame bar 48 via joints 60. Thus the frame bar 48 can move in its length direction back and forth in relation to the frame 6 of the cultivation device 2, as far as allowed by the limiters 62 fastened to the fastening bodies 54. The harrow blades 52 of the embodiment are in this embodiment example made of plastics, and with the aid of springs 64 they are fastened at equal distances and mutually in parallel to the frame bar 48. The frame bar 48 can be turned stepwise around its longitudinal axis with the aid of the adjustment means 58, and thereby it is possible to act on the height and position of the harrow blades 52.

By adding the harrow 46 to form a part of the cultivation device 2 according to the invention the cultivation device 2 can provide a uniform cultivation result also in soils, which are difficult to cultivate, such as clay soils.

The invention is not intended to be restricted to the embodiments presented above as examples, but on the contrary, the invention should be widely interpreted within the scope defined by the claims presented below.

1-16. (canceled)

17. A cultivation device intended for the cultivation of soil and pulled by a vehicle, the device comprising a frame with a drawbar attached to the frame, or which frame is intended to be coupled to a drawbar; an attachment shaft for mouldboards, the shaft extending substantially in the direction of the longitudinal axis of the frame; mouldboards; and a drawbar which is coupled or can be coupled substantially centrally to the frame so that the angle, between the longitudinal axis of the frame being substantially horizontal and transversal regarding the driving direction during cultivation and the drawbar being substantially in parallel with the driving direction, is arranged to be adjustable, wherein
a) there are two types of mouldboards; first mouldboards which during cultivation turn the soil to the right in relation to said driving direction; and second mouldboards which during cultivation turn the soil to the left in relation to said driving direction;
b) the mouldboards are fastened to the mouldboard attachment shaft so that the first mouldboards are substantially parallel in relation to each other, the second mouldboards are substantially parallel in relation to each other, and the first mouldboards are directed in a substantially different direction in relation to the second mouldboards; and
c) the mouldboard attachment shaft is arranged to be rotated around its longitudinal axis so that there are at least two attachment shaft positions to be used in the cultivation; a first position where the first mouldboards are arranged during cultivation to turn the soil to the right in relation to said driving direction; and a second position where the second mouldboards are arranged during cultivation to turn the soil to the left in relation to said driving direction.

18. A cultivation device according to claim 17, wherein the cultivation device is a light cultivation device having a cultivation depth of about 5 to 15 cm, advantageously about 5 to 10 cm.

19. A cultivation device according to claim 17, wherein the cultivation device is a plough with a cultivation depth of about 10 to 25 cm, advantageously about 10 to 20 cm.

20. A cultivation device according to claim 17, wherein the angle between the drawbar and the frame can be adjusted into at least two different positions, whereby in the first position the acute angle between the drawbar and the longitudinal axis of the frame is on the right side in relation to said driving direction, and in the second position the acute angle is on the left side in relation to said driving direction.

21. A cultivation device according to claim 17, wherein the angle between the drawbar and the longitudinal axis of the frame is adjustable, advantageously in a stepless manner, between about 0° and 180°, advantageously between about 10° and 160°.

22. A cultivation device according to claim 17, wherein the first mouldboards and the second mouldboards are mirror images of each other.

23. A cultivation device according to claim 17, wherein the mouldboard attachment shaft is fastened at least at its both ends to the frame of the cultivation device.

24. A cultivation device according to claim 17, wherein the mouldboard attachment shaft is mounted in bearings at least at its both ends.

25. A cultivation device according to claim 17, wherein the mouldboard attachment shaft can be rotated about 180° around its longitudinal axis, advantageously about 90° or 60°.

26. A cultivation device according to claim 17, wherein each mouldboard is attached to the mouldboard attachment shaft with at least one shear pin.

27. A cultivation device according to claim 17, wherein the cultivation device has a wheel or wheels, advantageously a wheel at both ends of the frame, which wheels support the cultivation device.

28. A cultivation device according to claim 27, wherein the height of the wheel or wheels is arranged to be adjustable, so that the cultivation depth of the cultivation device is adjusted by adjusting the height.

29. A cultivation device according to claim 17, wherein an adjustment or some adjustments of the cultivation device; advantageously the angle between the drawbar and the longitudinal axis of the frame and/or the rotation of the mouldboard attachment shaft around its longitudinal axis; is or are hydraulic.

30. A cultivation device according to claim 17, wherein the means, which rotate the mouldboard attachment shaft into the first and second positions, lock the attachment shaft into the first position when soil is cultivated with the first mouldboards.

31. A cultivation device according to claim 17, wherein when the mouldboard attachment shaft is in its second position, which is used to cultivate the soil with the second mouldboards, the shaft can not be rotated further in that direction, into which the force acting on the mouldboards tends to rotate said attachment shaft during cultivation of the soil.

32. A cultivation device according to claim 17, wherein the cultivation device comprises a rear harrow.
